(19) United States
(12) Patent Application Publication
(10) Pub. No.: US 2007/0245896 A1
(43) Pub. Date: Oct. 25, 2007

(54) Modular nitrogen generator

(75) Inventors: Darin L. Thorp, Montpelier, OH (US); Spencer Zeedyk, Bryan, OH (US)

Correspondence Address: MICHAEL BEST & FRIEDRICH LLP, 100 E WISCONSIN AVENUE, Suite 3300, MILWAUKEE, WI, 53202, US

(73) Assignee: Ingersoll-Rand Company, Montvale, NJ (US)

(21) Appl. No.: 11/410,640

(22) Filed: Apr. 25, 2006

(51) Int. Cl. B01D 53/22

(52) U.S. Cl. 96/7

(57) ABSTRACT

A modular nitrogen generator including a housing including a bracket and defining an interior space, a flow path having an inlet adapted to receive compressed air and an outlet in fluid communication with a storage tank, an inlet manifold, an outlet manifold, and a modular membrane canister supportable on the mounting bracket within the interior space and positioned along the flow path between the inlet manifold and the outlet manifold to receive compressed air from the inlet manifold, extract nitrogen from the compressed air, and deliver the nitrogen to the outlet manifold. The flow path can be adapted to receive an additional modular membrane canister in a parallel flow configuration with the modular membrane canister to increase nitrogen output capacity of the nitrogen generator.

### FIELD OF THE INVENTION

The present invention relates to nitrogen generators utilizing modular membrane canisters to separate nitrogen from compressed air and to a method of operating the same. Specifically, the present invention relates to nitrogen generators that are expandable by adding additional modular membrane canisters.

### SUMMARY

In one embodiment, the invention provides a modular nitrogen generator including: a housing including a bracket and defining an interior space, a flow path having an inlet adapted to receive compressed air and an outlet in fluid communication with a storage tank, an inlet manifold, and an outlet manifold. The inlet manifold and the outlet manifold extend through the housing and can be positioned along the flow path between the inlet and the outlet. The modular nitrogen generator further includes a modular membrane canister supportable on the mounting bracket within the interior space and positioned along the flow path between the inlet manifold and the outlet manifold to receive compressed air from the inlet manifold, extract nitrogen from the compressed air, and deliver the nitrogen to the outlet manifold. The flow path can be adapted to receive an additional modular membrane canister in a parallel flow configuration with the modular membrane canister to increase nitrogen output capacity of the nitrogen generator, and the bracket can be adapted to support the additional modular membrane canister in the interior space.

In another embodiment the invention provides a method of operating a modular nitrogen generator. The method includes the acts of: providing the nitrogen generator with a housing including a bracket and defining an interior space, an inlet manifold, an outlet manifold, an outlet, and a first modular membrane canister connected between the inlet manifold and the outlet manifold, The method further includes supplying compressed air to the first modular membrane canister through the inlet manifold, separating nitrogen from the compressed air as the compressed air flows through the first modular membrane canister, directing the separated nitrogen from the first modular membrane canister to the outlet manifold, directing the nitrogen from the outlet manifold to the outlet, and coupling a second modular membrane canister to the bracket, coupling a first end of the second modular membrane canister to the inlet manifold, and coupling a second end of the second modular membrane canister to the outlet manifold, such that at least some of the compressed air is directed away from the first modular canister and through the second modular membrane canister to expand nitrogen output capacity of the nitrogen generator.

Other aspects of the invention will become apparent by consideration of the detailed description and accompanying drawings.

### BRIEF DESCRIPTION OF THE DRAWINGS

FIG. 1 is a front perspective view of a nitrogen generator according to an embodiment of the present invention.

FIG. 2 is a rear perspective view of the nitrogen generator shown in FIG. 1.

FIG. 3 is a front perspective view of the nitrogen generator shown in FIG. 1 with a front cover removed.

FIG. 4 is a front view of a portion of the nitrogen generator shown in FIG. 1.

FIG. 5 is a front perspective view of a second configuration of the nitrogen generator shown in FIG. 1 with the front cover removed.

FIG. 6 is a front perspective view of a third configuration of the nitrogen generator shown in FIG. 1 with the front cover removed.

FIG. 7 is a front perspective view of a fourth configuration of the nitrogen generator shown in FIG. 1 with the front cover removed.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

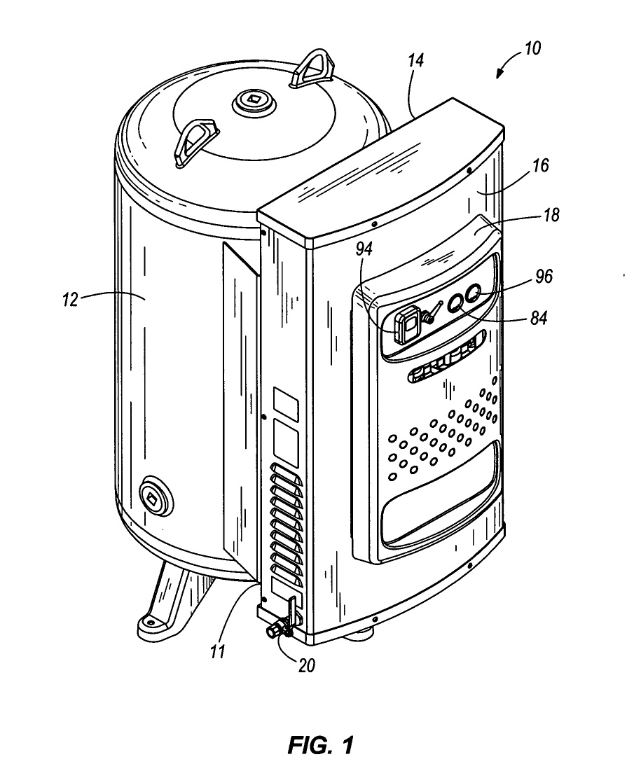

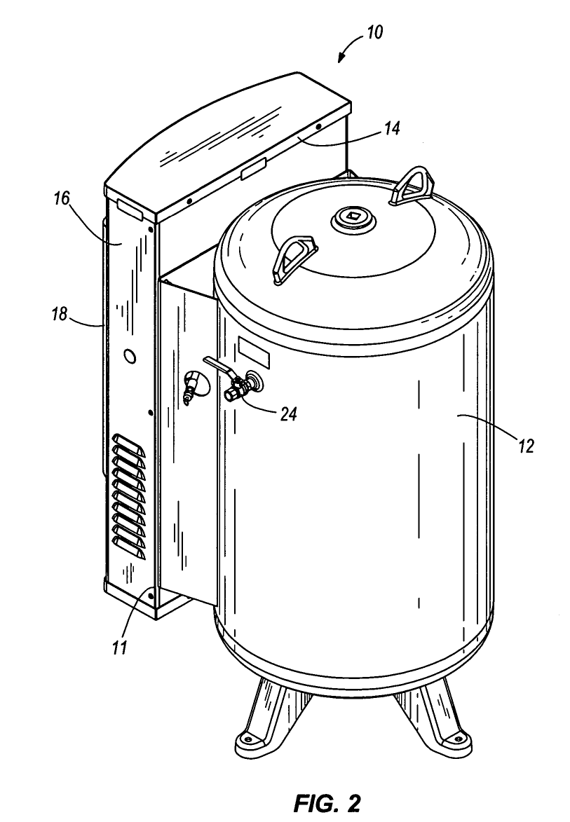

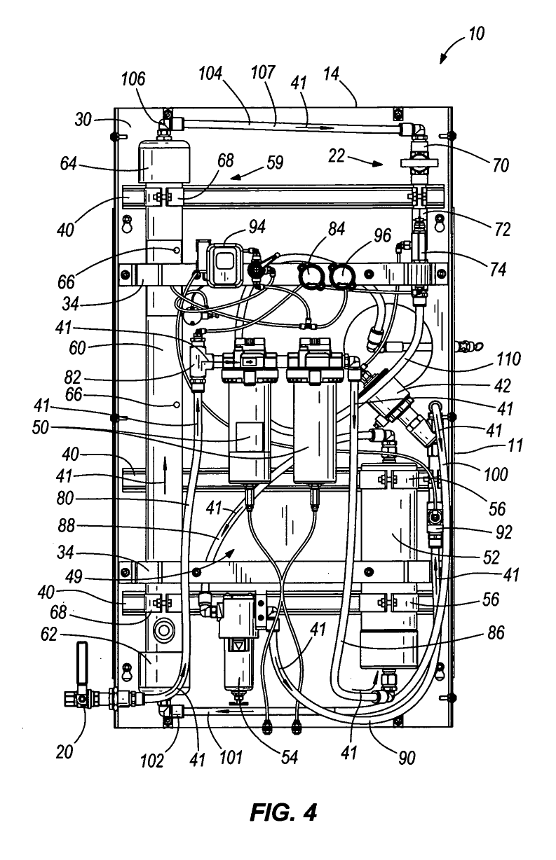

FIGS. 1-7, illustrate a modular nitrogen generator 10 including a generator body 11 and a storage tank 12. The generator 10 of the illustrated embodiment includes a housing 14 having first and second removable covers 16, 18. As shown in FIGS. 1-7, the nitrogen generator 10 can also include an inlet 20 for receiving compressed air, a body outlet 22 for directing nitrogen from the generator body 11 to the storage tank 12, and a nitrogen outlet 24 on the storage tank 12 for dispensing nitrogen from the nitrogen generator 10. In the illustrated embodiment of FIGS. 1-7, the inlet 20 and outlet 24 include valves for controlling fluid flow into and out of the nitrogen generator 10 and the storage tank 12. In other embodiments, valves can be positioned and located throughout the nitrogen generator 10 for controlling fluid flow into, through, and out of the nitrogen generator 10.

The storage tank 12 in the illustrated embodiment of FIGS. 1-7 is substantially cylindrical and includes a generally round cross-sectional shape. In other embodiments, the storage tank 12 can have any cross-sectional shape, including without limitation oval, polygonal, irregular, triangular, rectangular, and other cross-sectional shapes. As shown in FIGS. 1-7, the generator body 11 can be secured to the storage tank 12. In other embodiments, the generator body 11 can be positioned remotely with respect to the storage tank 12 and one or more conduits can fluidly connect the generator body 11 and the storage tank 12.

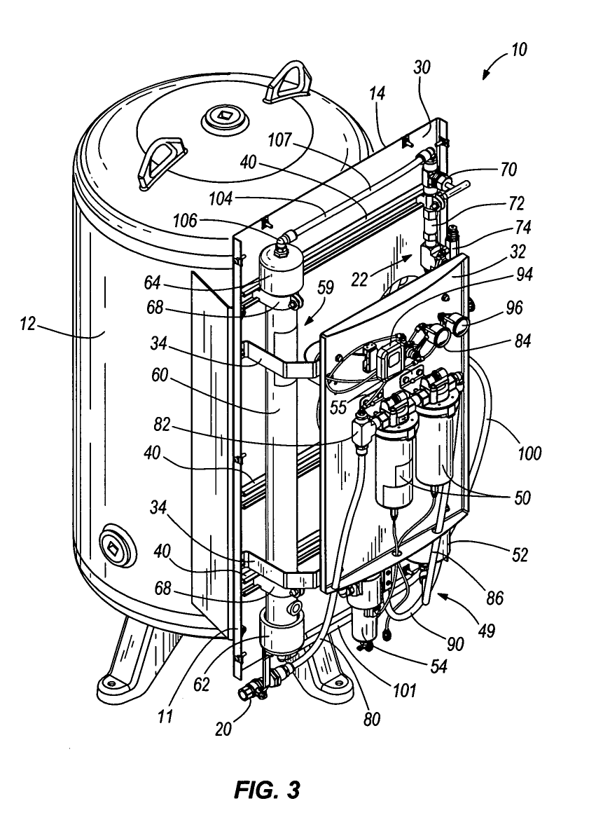

FIG. 3 illustrates the nitrogen generator 10 with the covers 16, 18 removed. A first plate 30 defines a rearward portion of the housing 14, and is configured to support a number of elements within the nitrogen generator 10. A second plate 32 is positioned forwardly from the first plate 30, and is connected to the first plate 30 with supports 34. As shown in FIGS. 3 and 5-7, the second plate 32 can be configured to support other nitrogen generator 10 elements.

As shown in FIGS. 3-7, mounting brackets 40 extend through the housing 14 and are secured to the first plate 30. In the illustrated embodiment, the brackets 40 are spaced apart such that a first bracket 40 is positioned adjacent to an upper end of the first plate 30 and a second bracket 40 is spaced a distance below the first bracket 40. In other embodiments, the brackets 40 can have other relative orientations, depending upon one or more of the shape and size of the housing 14, the shape and size of the first plate 30, and the number and size of membrane canisters supported in the housing 14. In still other embodiments, the nitrogen generator 10 can include one, three, or more brackets 40 positioned in the housing 14. In the illustrated embodiment of FIGS. 3-7, the mounting brackets 40 are Uni-Strut P3300-PG. In other embodiments, other mounting brackets are utilized with similar effect.

As shown in FIGS. 3-7, the nitrogen generator 10 can include a flow path (represented by arrows 41) extending between the inlet 20 and the outlet 24. The inlet 20 is configured to be connected to a source of compressed air, and includes a valve to control the flow of the compressed air entering the generator 10

In the illustrated embodiment of FIGS. 1-7, the nitrogen generator 10 includes a filtration system 49 positioned along the flow path 41 and having a pair of coalescing filters 50, a carbon bed 52, and a carbon filter element 54. In the illustrated embodiment, the coalescing filters 50 remove water particles, oil particles, and other contaminants from the compressed air. The coalescing filters 50 in the illustrated embodiment are capable of removing about 99.9 percent of all particles greater than or approximately equal to about 0.01 micrometers in diameter. In some embodiments, the coalescing filter 50 can be a Reading Technologies, Inc. IR1500 filter. In other embodiments, other coalescing filters and filter elements can also or alternately be used.

As shown in FIGS. 3-7, clamps 55 can secure the coalescing filters 50 to the second plate 32. In some embodiments, such as the illustrated embodiment, Reading Technologies, Inc. BK-1 clamps 55 can be used. In other embodiments, other mounting brackets and clamps can also or alternately be used.

In the illustrated embodiment of FIGS. 3-7, during operation of the nitrogen generator 10, compressed air is forced through the carbon bed 52 to remove water and/or oil particles from the compressed air not removed by the coalescing filters 50. In some embodiments, the carbon bed 52 is a Reading Technologies, Inc. IR1500-ACV carbon bed. In other embodiments, other filters and filtering elements can also or alternately be used. As shown in FIGS. 3-7, the carbon bed 52 can be supported by clamps 56, which can be connected to the mounting brackets 40. The clamps 56 of the illustrated embodiment are Uni-Strut P2052-EG clamps. In other embodiments other clamps 56 can also or alternately be used.

In embodiments, such as the illustrated embodiment, in which the filtration system 49 includes carbon filters 54, one or more carbon filers 54 are secured to a rear side of the second plate 32 with mounting brackets, such as, for example, Reading Technologies, Inc. N34-95-969-BK brackets. In other embodiments, other clamps and brackets can also or alternately be used.

In the illustrated embodiment, the carbon filter 54 is a Reading Technologies, Inc. IR1500-AF filter and is operable to remove any carbon dust that may have collected in the compressed air while passing through the carbon bed 52. In other embodiments, other filters and filtering elements can also or alternately be used.

As shown in FIGS. 3-7, the nitrogen generator 10 can also include a separation system 59 having at least one modular membrane canister 60, such as, for example, an Air Liquide/Medal 4241 canister. In the illustrated embodiment of FIGS. 3-7, the modular membrane canisters 60 can include a substantially cylindrical housing that surrounds a bundle of long, thin tubes having porous walls. During operation of the nitrogen generator 10, compressed air is forced into the tubes as it enters a first end 62 of a membrane canister 60. As the compressed air passes through the tubes, smaller oxygen molecules tend to pass radially outwardly through the porous walls, while larger nitrogen molecules tend to flow through the length of the tubes without passing through the porous walls.

Apertures 66 are located along the length of each of the modular membrane canisters 60 for venting oxygen molecules exiting the thin tubes to atmosphere. The tubes supported in the modular membrane canisters 60 terminate at a second end 64 of the membrane canisters 60. As the compressed air travels through the modular membrane canisters 60 toward the second ends 64 of the modular membrane canisters 60, most of the oxygen is removed from the compressed air while most of the nitrogen molecules are retained so that the fluid exiting the second ends 64 of modular membrane canisters 60 includes a relatively high concentration of nitrogen molecules and a relatively low concentration of oxygen molecules.

In the illustrated embodiment of FIGS. 3-7, clamps 68, such as, for example, Uni-Strut P2042-EG clamps, secure the membrane canisters 60 to one or more of the mounting brackets 40. In other embodiments, other clamps 68 can also or alternately be used.

As shown in FIGS. 3-7, the nitrogen generator outlet 22 can includes a metering valve 70, a check valve 72, and a pressure sensor 74. In embodiments, such as the illustrated embodiment, having a metering valve 70, the metering valve 70 is adjustable to control the flow of nitrogen leaving the generator 10. The metering valve 70 can be a ball valve, gate valve, or other similar valve capable of controlling or regulating fluid flow.

The check valve 72 can be positioned between the metering valve 70 and the pressure sensor 74. In the illustrated embodiment of FIGS. 3-7, the check valve 72 is a one-way valve that permits the flow of nitrogen outwardly from the generator body 11 to the storage tank 12, but does not permit the flow of nitrogen from the storage tank 12 back into the generator body 11. As shown in FIGS. 3-7, the pressure sensor 74 can be positioned between the check valve 72 and the storage tank 12 to measure the pressure of the nitrogen stored in the storage tank 12.

In some embodiments, such as the illustrated embodiment of FIGS. 3-7, the nitrogen generator 10 can include a shut-off valve 42 for regulating the pressure in the storage tank 12 measured by the pressure sensor 74. In the illustrated embodiment, the shut-off valve 42 is positioned between the filtration system 49 and the separation system 59.

During operation, the shut-off valve 42 is closed when the pressure in the storage tank 12 reaches a pre-determined limit, preventing compressed air from flow along the flow path 41 from the filtration system 49 into the separation system 59. When the pressure in the storage tank 12 drops below a predetermined limit, the shut-off valve 42 can be opened, causing compressed air to flow along the flow path 41 from the filtration system 49 into the separation system 59.

Compressed air enters the nitrogen generator 10 through the inlet 20 and flows along the flow path 41, through a conduit 80, through a fitting 82 and into the coalescing filters 50. In some embodiments, a pressure gauge 84 is positioned along the flow path 41 for recording the air pressure in the flow path 41. In some such embodiments, the pressure gauge 84 can include a display visible to an operator of the generator 10 through the cover 18. In the illustrated embodiment of FIGS. 3-7, the pressure gauge 84 is connected to the fitting 82 to measure the pressure of air entering the filtration system 49. In other embodiments, pressure gauges and other sensors can be located in other locations along the flow path 41 for monitoring air flow through the flow path 41.

The compressed air then flows along the flow path 41 through the coalescing filters 50, a second conduit 86, the carbon bed 52, and a third conduit 88 before entering the carbon filter 54. After passing through the filtration system 49, the clean compressed air flows from the carbon filter 54, along the flow path 41, through a fourth conduit 90, and toward a fitting 92.

In the illustrated embodiment of FIGS. 3-7, an air purity gauge 94 and a pressure gauge 96 are positioned along the flow path 41 and are connected to the fitting 92 to measure the purity or quality of air leaving the filtration system 49 and the pressure of the cleaned compressed air, respectively. As shown in FIGS. 3-7, the air purity gauge 94 and the pressure gauge 96 can be connected to the second plate 32 and can include displays that are visible to an operator from outside the housing 14.

From the fitting 92, the compressed air flows along the flow path 41 through the automatic shut-off valve 42, through a fifth conduit 100, and into an inlet manifold 101. From the inlet manifold 101, the compressed air flows through an elbow fitting 102 and into the first end 62 of a modular membrane canister 60, where oxygen is separated and removed from the compressed air, leaving relatively pure nitrogen.

From the second end 64 of the modular membrane canister 60, the nitrogen flows along the flow path 41 through an elbow fitting 106 and outwardly along an outlet manifold 107, including a sixth conduit 104. From the outlet manifold 107, the nitrogen flows through the metering valve 70 and past the pressure sensor 74 before exiting the flow path 41 through a seventh conduit 110 toward the storage tank 12 where the relatively pure nitrogen is stored.

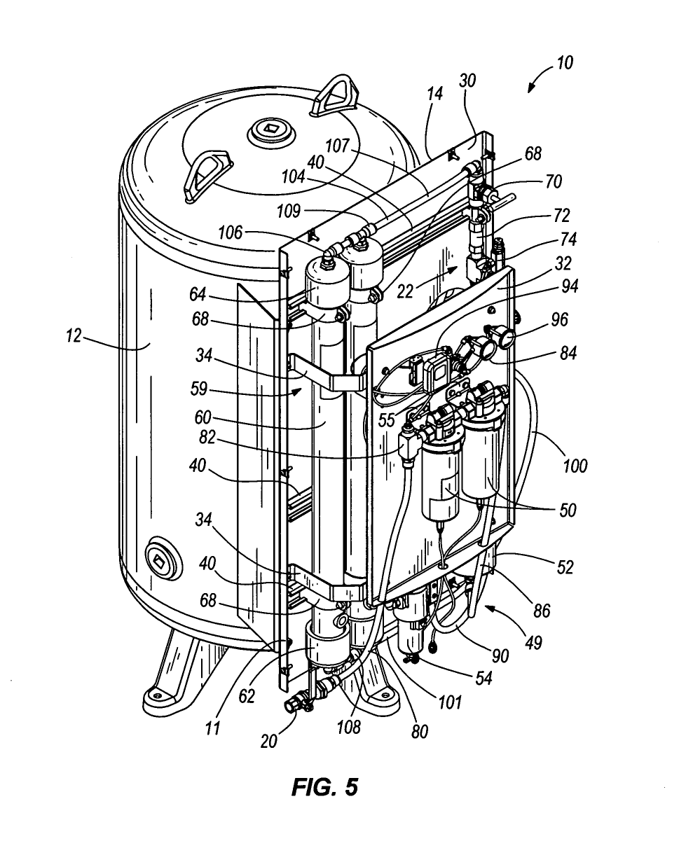

In some embodiments, such as the illustrated embodiment of FIGS. 1-7, the flow path 41 of the nitrogen generator 10 can be reconfigured to adjust the nitrogen output capacity of the nitrogen generator 10. For example, as shown in FIG. 5, tee-shaped fittings 108, 109 can be connected to the inlet and outlet manifolds 101, 107, respectively. A second modular membrane canister 60 can then be added to the nitrogen generator 10 and can be connected to the flow path 41 to increase the nitrogen output of the nitrogen generator 10.

In the illustrated embodiment of FIG. 5, the first and second modular membranes 60 are connected between the inlet and outlet manifolds 101, 107 to provide a parallel flow configuration such that a first portion of the compressed air is directed through the first modular membrane canister 60 and a second portion of the compressed air is directed through the second modular membrane canister 60, thereby significantly increasing the nitrogen output capacity of the nitrogen generator 10.

As shown in FIG. 5, clamps 68, such as, for example, Uni-Strut P2042-EG, secure the modular membrane canisters 60 to one or more of the mounting brackets 40. In other embodiments, other clamps 68 can also or alternately be used.

In the illustrated embodiment of FIG. 5, longitudinal axes of the modular membrane canisters 60 are substantially parallel. In other embodiments, the modular membrane canisters 60 can have other relative orientations and configurations while still being connected along the flow path 41 in a parallel flow configuration such that a first portion of the compressed air is directed through the first modular membrane canister 60 and a second portion of the compressed air is directed through the second modular membrane canister 60.

For example, in some embodiments, the longitudinal axes of the first and second modular membrane canisters 60 can be substantially normal or at an acute angle with respect to one another. In other embodiments, the first and second modular membrane canisters 60 can have other relative orientations and configurations wile still being connected along the flow path 60 in a parallel flow configuration.

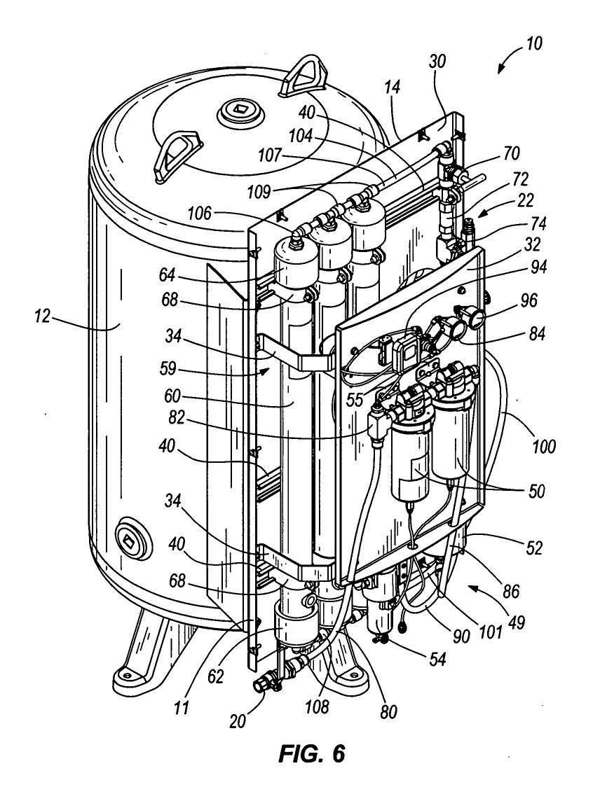

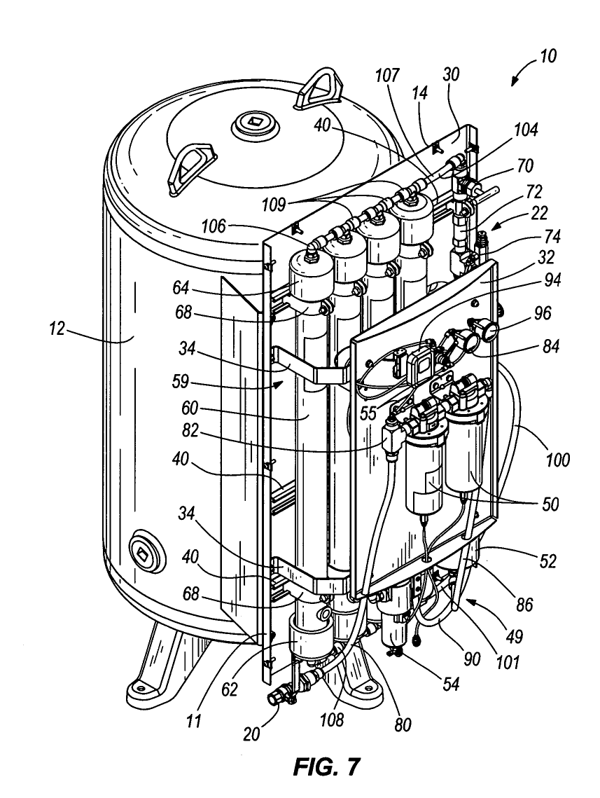

As shown in FIG. 6 and in FIG. 7, in some embodiments, third and fourth modular membrane canisters 60 can also or alternately be connected to the flow path 41 such that the first, second, third, and fourth modular membrane canisters 60 are all connected in a parallel flow configuration to further increase the nitrogen output capacity of the nitrogen generator 10. In these embodiments, additional tee shaped fittings 108, 109 can be connected to the inlet and outlet manifolds 101, 107 to connect the third and fourth modular membrane canisters 60 to the flow path 41.

As shown in FIGS. 6 and 7, clamps 68, such as, for example, Uni-Strut P2042-EG, secure the modular membrane canisters 60 to one or more of the mounting brackets 40. In other embodiments, other clamps 68 can also or alternately be used. In the illustrated embodiment of FIGS. 3-7, the mounting brackets 40 are sized to support as many as four modular membrane canisters 60. In the illustrated embodiment, the length of the brackets 40 is greater than four times the width of each of the modular membrane canisters 60. In this manner, an operator can purchase and operate a nitrogen generator 10 having a first nitrogen output and then add additional modular membrane canisters 60 to the nitrogen generator 10 to significantly increase the nitrogen output capacity of the nitrogen generator 10 without being required to purchase costly new equipment and/or make significant modifications to the nitrogen generator 10.

Various alternatives and embodiments are contemplated as being within the scope of the following claims particularly pointing out and distinctly claiming the subject matter regarded as the invention.

What is claimed is:

1. A modular nitrogen generator comprising:
a housing including a bracket and defining an interior space;
a flow path having an inlet adapted to receive compressed air and an outlet in fluid communication with a storage tank;
an inlet manifold;
an outlet manifold, the inlet manifold and the outlet manifold extending through the housing and being positioned along the flow path between the inlet and the outlet; and
a modular membrane canister supportable on the mounting bracket within the interior space and positioned along the flow path between the inlet manifold and the outlet manifold to receive compressed air from the inlet manifold, extract nitrogen from the compressed air, and deliver the nitrogen to the outlet manifold;
wherein the flow path is adapted to receive an additional modular membrane canister in a parallel flow configuration with the modular membrane canister to increase nitrogen output capacity of the nitrogen generator, and wherein the bracket is adapted to support the additional modular membrane canister in the interior space.

2. The nitrogen generator of claim 1, further comprising a metering valve adapted to control a flow rate of nitrogen through the outlet.

3. The nitrogen generator of claim 1, further comprising a clamp substantially surrounding a portion of one of the modular membrane canister and the additional modular membrane canister, the clamp being connectable to the bracket to support the one of the modular membrane canister and the additional modular membrane canister.

4. The nitrogen generator of claim 3, further comprising a second clamp substantially surrounding a portion of an other of the modular membrane canister and the additional modular membrane canister, the second clamp being connectable to the bracket to support the other of the modular membrane canister and the additional modular membrane canister.

5. The nitrogen generator of claim 1, wherein the additional modular membrane canister is supported within the interior space adjacent to the modular membrane canister.

6. The nitrogen generator of claim 1, wherein the modular membrane canister includes a width, and wherein the bracket extends to a length of at least two times the width of the modular membrane canister.

7. The nitrogen generator of claim 1, further comprising a filter system positioned along the flow path and operable to remove contaminants from the compressed air.

8. The nitrogen generator of claim 1, wherein the bracket can support at least four modular membrane canisters.

9. The nitrogen generator of claim 1, further comprising first tee fittings positioned along the inlet manifold and second tee fittings positioned along the outlet manifold, and wherein the additional modular membrane canister is engageable with one of the first tee fittings and one of the second tee fittings to increase the nitrogen output capacity of the nitrogen generator.

10. The nitrogen generator of claim 1, wherein the housing includes a second bracket, and wherein the modular membrane canister is supportable between the first bracket and the second bracket.

11. The nitrogen generator of claim 10, wherein the additional modular membrane canister is supportable between the first bracket and the second bracket.

12. The nitrogen generator of claim 1, wherein the modular membrane canister defines a longitudinal axis, wherein the additional modular membrane canister defines a second longitudinal axis, and wherein the bracket supports the modular membrane canister and the additional modular canister in the interior space such that the first axis is substantially parallel to the second axis.

13. A method of operating a modular nitrogen generator, the method comprising the acts of:
providing the nitrogen generator with a housing including a bracket and defining an interior space, an inlet manifold, an outlet manifold, an outlet, and a first modular membrane canister connected between the inlet manifold and the outlet manifold;
supplying compressed air to the first modular membrane canister through the inlet manifold;
separating nitrogen from the compressed air as the compressed air flows through the first modular membrane canister;
directing the separated nitrogen from the first modular membrane canister to the outlet manifold;
directing the nitrogen from the outlet manifold to the outlet; and
coupling a second modular membrane canister to the bracket, coupling a first end of the second modular membrane canister to the inlet manifold, and coupling a second end of the second modular membrane canister to the outlet manifold, such that at least some of the compressed air is directed away from the first modular canister and through the second modular membrane canister to expand nitrogen output capacity of the nitrogen generator.

14. The method of claim 13, wherein providing the nitrogen generator with the first modular membrane canister includes substantially surrounding a portion of the first membrane canister with a clamp and coupling the clamp to the bracket.

15. The method of claim 13, wherein coupling the second modular membrane canister to the bracket includes substantially surrounding a portion of the second modular membrane canister with a clamp and coupling the clamp to an open length of the bracket.

16. The method of claim 13, wherein coupling the first end of the second modular membrane canister to the inlet manifold includes attaching a first end of a tee fitting to the first end of the second modular membrane canister and attaching second and third ends of the tee fitting to the inlet manifold, such that the first end of the second modular membrane canister is in fluid communication with the inlet manifold.

17. The method of claim 13, wherein coupling the second end of the second modular membrane canister to the outlet manifold includes attaching a first end of a tee fitting to the second end of the second modular membrane canister and attaching second and third ends of the tee fitting to the outlet manifold, such that the second end of the second modular membrane canister is in fluid communication with the outlet manifold.

18. The method of claim 13, further comprising providing a second bracket substantially parallel to the first bracket and supporting each of the first and second modular membrane canisters with the first bracket and the second bracket.

19. The method of claim 13, wherein the nitrogen generator includes a flow path extending through the inlet manifold, the outlet manifold, the first modular membrane canister, and the outlet, and wherein coupling the first end of the second modular membrane canister to the inlet manifold and coupling the second end of the second modular membrane canister to the outlet manifold includes positioning the second modular membrane canister along the flow path such that the second modular membrane canister is connected in a parallel flow configuration with respect to the first modular membrane canister between the inlet manifold and the outlet manifold.

20. The method of claim 13, wherein the first modular membrane canister defines a first longitudinal axis, wherein the second modular membrane canister defines a second longitudinal axis, and wherein coupling the second modular membrane canister to the bracket includes orienting the second modular membrane canister in the interior space such that the second axis is substantially parallel to the first axis.

21. The method of claim 13, wherein the nitrogen generator includes a flow path extending through the inlet manifold, the outlet manifold, the first modular membrane canister, and the outlet, and further comprising directing the compressed air through a filter system positioned along the flow path and removing contaminants from the compressed air before the compressed air is supplied to the first modular membrane canister.
